(19) United States
(12) Patent Application Publication
(10) Pub. No.: US 2016/0144452 A1
(43) Pub. Date: May 26, 2016

(54) SYSTEM AND METHOD FOR DETECTING A DEFECT IN A WORKPIECE UNDERGOING MATERIAL PROCESSING BY AN ENERGY POINT SOURCE

(71) Applicant: Product Innovation & Engineering, LLC, St. James, MO (US)

(72) Inventors: Fuewen Frank Liou, St. James, MO (US); Todd E. Sparks, Rolla, MO (US)

(73) Assignee: Product Innovation & Engineering, LLC, St. James, MO (US)

(21) Appl. No.: 14/550,330

(22) Filed: Nov. 21, 2014

(51) Int. Cl. B23K 26/03; B23K 15/00

(52) U.S. Cl. CPC B23K 26/032; B23K 15/0013

(57) ABSTRACT

A method for detecting a subsurface defect in a workpiece undergoing processing includes directing focused heat energy from an energy point source on to the workpiece to generate a melt pool and cause a solid portion of the workpiece to emit incandescent radiation. The incandescent radiation emitted by the solid portion of the workpiece is captured and a signal based upon the color or intensity of the captured incandescent radiation is output. A processor receives the output signal and analyzes it for any variance. If any variance is detected, the region associated with the variance is determined. In this fashion, gradients in the color or intensity distribution reveal subsurface defects.

### CROSS REFERENCE TO RELATED APPLICATION

Not applicable.

### STATEMENT REGARDING FEDERALLY SPONSORED RESEARCH OR DEVELOPMENT

Not applicable.

### SEQUENCE LISTING, TABLE OR COMPUTER PROGRAM ON COMPACT DISC

Not applicable.

### FIELD OF INVENTION

This invention relates to techniques for detecting defects in a substrate receiving beam energy such as would occur during laser deposition processing and cladding and also during welding, plasma torch welding, thermal spray and electron beam techniques.

### BACKGROUND OF THE INVENTION

Current material processing methods use energy point sources to fabricate and repair parts. Such material processing techniques include welding and additive manufacturing. These processes use an energy point source, such as a laser, electron beam emitter, TIG welder or plasma torch, to focus emitted heat energy to a workpiece. In all of these techniques an energy point source directs energy upon a workpiece and creates a melt pool where the focused energy is incident upon the workpiece. In the case of welding, the melt pool is often referred to as a “weld pool.”

As shown in FIG. 1, in any energy point source processing technique the heat source is focused onto a workpiece 1, producing the melt or weld pool 8. The laser energy 4 directed at the workpiece is absorbed by the workpiece and causes local heat manifested in the solid portion 6 of the workpiece that includes the areas known as the hot zone 9 and bulk structure 10. Hot zone 9 typically constitutes several regions, 9a, 9b, 9c, having different heat amounts. The quality of the process is highly dependent on defining and maintaining the optimal conditions of the beam emitted by the beam source. Defects that may occur within processed regions of metals include voids, pores, bondlines (incompletely formed bonds), disbonds and cracks. Material processing defects often occur or exist below the surface of the processed region where they cannot be detected by conventional surface monitoring. The presence of subsurface defects is not acceptable. Material processing techniques often involve costly workpieces and materials. For example, direct metal deposition is primarily used for high performance metals, including titanium alloys, Inconel, and tool steel. These metals are often the critical components of a structure in applications such as an aircraft wing, body joints and medical implants.

Careful observation and control of system parameters (e.g. energy input, traverse speed) is important in order to obtain a finished product that is free from defects. For example, one method directed to eliminating processing defects is preventing their formation by setting tighter process requirements via defining tight process specifications or allowables testing. However, due to part-to-part and machine-to-machine variations that limit repeatability, most of the current deposition machines cannot meet such tight requirements or testing. Other methods involve monitoring melt pool size or condition. During metal deposition, the melt pool changes with temperature from one layer to the next due to heat accumulation. The current strategy is to monitor melt pool size as an indication of temperature for process control. However, this method uses control process parameters to try to maintain “constant” temperature. Its effectiveness is undercut due to other process parameters and part geometry. In addition, these methods suffer from the fact that they are indirect methods for defect monitoring. Also defects, such as porosities and cracks, may not be addressed with this approach. Thus, even with careful observation and control, defects may still occur during metal processing.

Because quality and reliability of processed metal parts is critical, there are several known methods directed to detecting sub-surface defects that can occur during metal processing. One such method involves using non-destructive evaluation (NDE) to inspect the deposited parts. NDE is not adequate in the case of a part with an irregular surface finish as such a finish can obscure NDE results. In addition, if a part is found to have a defect, there may not be many good options to correct the defect after the part has been fabricated. Indeed, once the entire part is built, it is very impractical to repair a defect somewhere within the part as these parts can be very hard and have high strength.

Thus, it would be ideal if such defects were detected in-line during material processing. This would minimize scrap and improve product quality via timely corrective action, which could include adjusting processing parameters or interrupting the process. Thus, in-process monitoring of the deposition quality is critical. Unfortunately, material deposition processes occur at high speeds and there do not currently exist rapid and accurate techniques for in-process monitoring and control. For example, U.S. Pat. No. 7,009,695 teaches a process in which an area of a substrate is imaged with and without heating to obtain a hot image and a cold image respectively. The hot and cold images are compared with one another to identify one or more locations as being defective. This method suffers from the fact that it requires repeatedly heating, imaging and comparing images under various conditions. U.S. Published Patent Application No. 20130256528 discloses a buried defect detecting process that uses an imaging apparatus to collect the backscattered electrons emitted from the target microscopic metal feature due to impingement of the charged particles. U.S. Pat. No. 8,759,770 discloses a method that relies upon an infrared detection device for capturing infrared images of a multilayered coating. In this last reference, a processing unit is in electronic communication with the infrared detection device. The processing unit generates a subsurface defect map of the multilayer coating based on the infrared images. This method has application to materials with low thermal conductivity that are coated onto metal parts and not for homogenous metals as are involved in cladding and welding. In addition, the method of this patent is not appropriate for use during in situ detection during metal processing procedures as it captures infrared images over a period of time as thermal energy dissipates from the thermal bond coating and requires stitching the images together to form a map of the defects. U.S. Published Patent Application No. 20120259562 reveals a system in which a plasma-facing sensor is coupled to a first plate of a measuring capacitor. This system also includes a detection arrangement that is coupled to a second plate of the measuring capacitor, wherein the detection arrangement is configured for converting an induced current flowing through the measuring capacitor into a set of digital signals, which is processed to detect the in-situ arcing events. U.S. Pat. No. 4,854,710 is directed to a method in which a periodic energy source is applied to the surface of the semiconductor sample to generate a periodic electron-hole plasma. This plasma interacts with features in the sample as it diffuses. The plasma affects the index of refraction of the sample and the changing plasma density is monitored using a radiation probe.

Other references have proposed using ultrasonic waves for detecting subsurface defects. U.S. Pat. No. 6,019,000 is one such reference. This patent teaches using ultrasonic waves to perform in-situ measurements to determine the properties of the films deposited on substrates in the course of various semiconductor or processing steps. Conventional ultrasonic methods are discussed and distinguished in U.S. Pat. No. 7,278,315. In the case of the method disclosed in this patent, a probe Rayleigh wave is generated in the workpiece substrate by directing a laser beam of small dimensions to a predetermined generation area within the processed region of the substrate.

To the extent they can be employed with metal processing, the above disclosed techniques suffer from the drawback that they involve several adjunct components or steps that can overly complicate or slow down the specific metal processing procedure at issue. For example, ultrasonic detection does not efficiently allow for the feedback on the quality of the processed region necessary to controlling waste and errors that can occur in deposition and welding. Additionally, ultrasonic defect detecting techniques generally require smooth metallic surfaces for accurate detection or additional equipment such as a detection beam generator and an interferometer. In view of the deficits of the foregoing prior art methods, there is thus a need in the art for an improved method and system for in-process detection of subsurface defects in workpieces during metal processing techniques.

### SUMMARY OF THE INVENTION

The present invention method and system provide for direct and efficient defect detection. Experience has shown that in the case of a homogeneous substrate receiving energy from a point source and having a subsurface defect, the material above the defect will have a higher temperature than the material without a defect underneath. This temperature difference results in a thermal conductivity difference between the solid material and the structural inhomogeneity (defect) caused by the defect. The area with the defect will yield a higher incandescence (radiation within the visible light spectrum). In turn, the incandescence difference can be characterized by color or intensity gradient instead of the temperature itself.

In contrast to the above-described prior art methods, the present invention detects subsurface defects in-process quickly and without any additional system componentry other than a sensor device to capture process-generated incandescent radiation coming from the workpiece. Specifically, the inventive method and system uses in-situ color or intensity gradient difference to detect a defect in the solidified portions of the homogeneous workpiece. Because color or intensity gradient difference is relative, the invention relies on detecting a color or intensity gradient in incandescent radiation coming from the solid portions of the workpiece as opposed to relying upon the measurement of an exact or specific temperature of the workpiece itself. Hence, the requirements of the sensor needed for the invention are reduced. Sensors that can accurately measure temperature are very costly. With the present invention, that excessive cost can be avoided because the invention relies not upon absolute temperature measurement, but upon detecting gradient differences in radiation coming from the solid portion of the workpiece.

In general, an embodiment process of the present invention involves using the in-process energy to heat a region of the homogeneous material for purposes of fabrication or welding in order to detect subsurface defects. While the process is ongoing, an in-situ photon measurement device (sensor), such as a camera, photodiode, CCD or other device is used to detect the gradient by detecting a change in incandescence caused by the effective thermal conductivity difference between the solid material and the inhomogeneity caused by the defect. The incandescence difference manifests as a color or intensity gradient instead of the temperature itself. The incandescence gradient, in turn, results in a variance in the electric signal output by the sensor. The signal is monitored and processed, such that any variance in the output electric signal can be used to detect a subsurface defect. Upon that detection, an appropriate command or response signal to the system controller can be emitted by the processor. Thus, instead of relying on other devices or scattering radiation, the inherent incandescence phenomenon of the process can be used to monitor the beam energy process and detect the defect.

Thus, in one embodiment the invention is directed to a method for detecting a subsurface defect in a homogenous (typically, but not necessarily metal) workpiece undergoing processing. The method comprises a step of directing focused heat energy from an energy point source on to the workpiece to generate a melt pool and cause a solid portion of the workpiece to emit incandescent radiation. Then, the incandescent radiation emitted by the solid portion of the workpiece resulting only from the directing of focused heat energy on to the workpiece is captured. The photon measurement device outputs an electric signal that will vary based upon the color or intensity of the captured incandescent radiation. The output electric signal is analyzed by a processor to determine if any variance in it exists. If any variance in the output electrical signal is detected, then the region of the workpiece associated with the variance in the output electrical signal is determined by the processor, which typically will have tool path data and part geometry data as additional inputs with which to determine the subject region.

In a preferred embodiment method the photon measurement device will also map the spatial distribution of the color or intensity of the captured incandescent radiation in furtherance of the processor determining the location of the variance-causing defect on the workpiece.

In another embodiment the invention is directed to a system for detecting a subsurface defect in a homogeneous (e.g., metal) workpiece undergoing processing. The embodiment system comprises an energy point source configured to deliver focused heat energy to the workpiece to generate a melt pool and cause a solid portion of the workpiece to emit incandescent radiation. The system includes a photon measurement device (e.g., a CCD or CMOS sensor) adapted to capture the incandescent radiation emitted by the solid portion of the workpiece due to the delivered focused heat energy. The photon measurement device can be part of a sensor system that includes focusing optics and filtering optics. The photon measurement device outputs a signal based upon the captured incandescent radiation, which signal will vary based upon the color or intensity of the radiation. The system also has a processor configured to a) process the signal output by the photon measurement device and determine if any variance in the output electric signal exists; and b) if any such variance exists, determine what region of the of the solid portion of the workpiece is associated with the variance of the output electric signal.

In the preferred embodiment system, the processor will also map the spatial distribution of the color or intensity of the captured incandescent radiation. In contrast to the prior art, the present invention system and method use the information of the temperature fluctuations of the solid structure due only from the processing heat injury and not from accessory devices to assess the integrity of the solid parts of the workpiece during the processing phase.

### BRIEF DESCRIPTION OF THE DRAWINGS

FIG. 1 depicts the work environment of a metal substrate undergoing processing (e.g., additive metal layering) that uses an energy point source to create the thermodynamic constituents (melt pool, hot zone and bulk portion) in the workpiece.

FIG. 2 is an elevation section view depicting a workpiece with a subsurface defect, the workpiece is not undergoing metal processing by an energy point source.

FIG. 3 is an elevation section view depicting a workpiece with a subsurface defect, the workpiece is undergoing metal processing by an energy point source.

FIG. 4 is a plan view depicting a workpiece with a subsurface defect, the workpiece is not undergoing metal processing by an energy point source.

FIG. 5 is a plan view depicting a workpiece with a subsurface defect (the defect shown in phantom), the workpiece is undergoing metal processing by an energy point source.

FIG. 6 is a surface intensity plot showing the relationship between defect size and intensity of emitted radiation.

FIG. 7 is a flow chart of an embodiment of the method for detecting a defect according to the present invention.

FIG. 8 is a diagram depicting an embodiment system of the present invention.

### DETAILED DESCRIPTION

The inventive system and method described herein use an in-situ monitoring sensor to detect defects through a change in incandescence caused by the effective thermal conductivity difference between the homogeneous solid material and the inhomogeneity caused by the defect. By using the in-process energy source instead of adjunct illuminating or scattering devices, the present invention reduces the cost and setup of subsurface defect monitoring. The technique is especially useful for fabrication processes with thinner deposition, such as additive manufacturing, cladding, coating or welding.

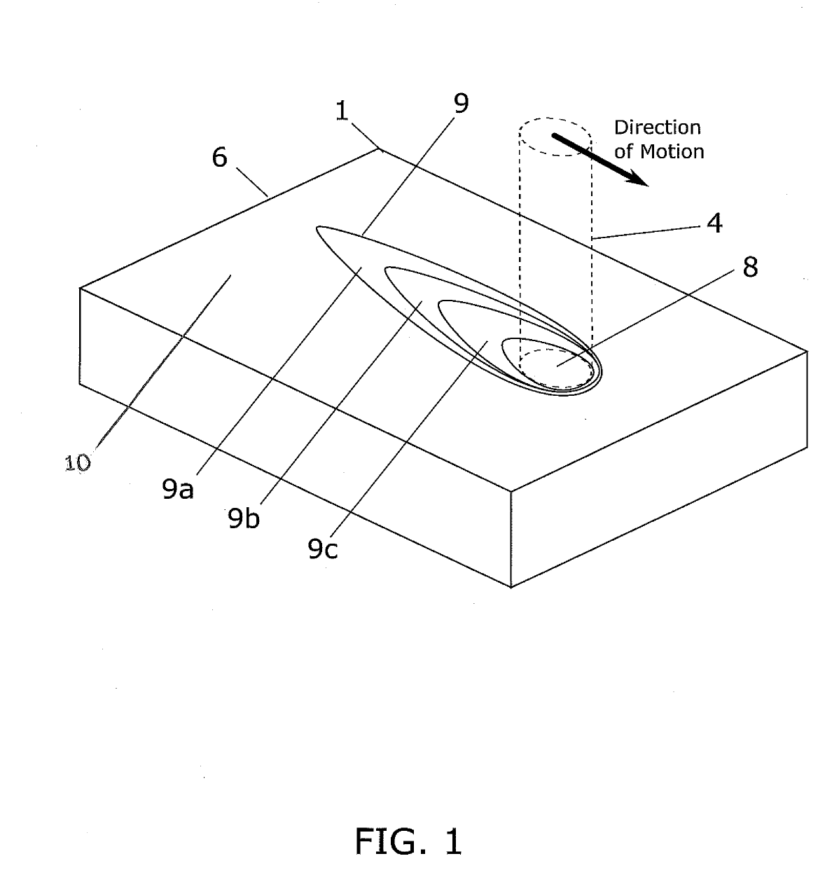

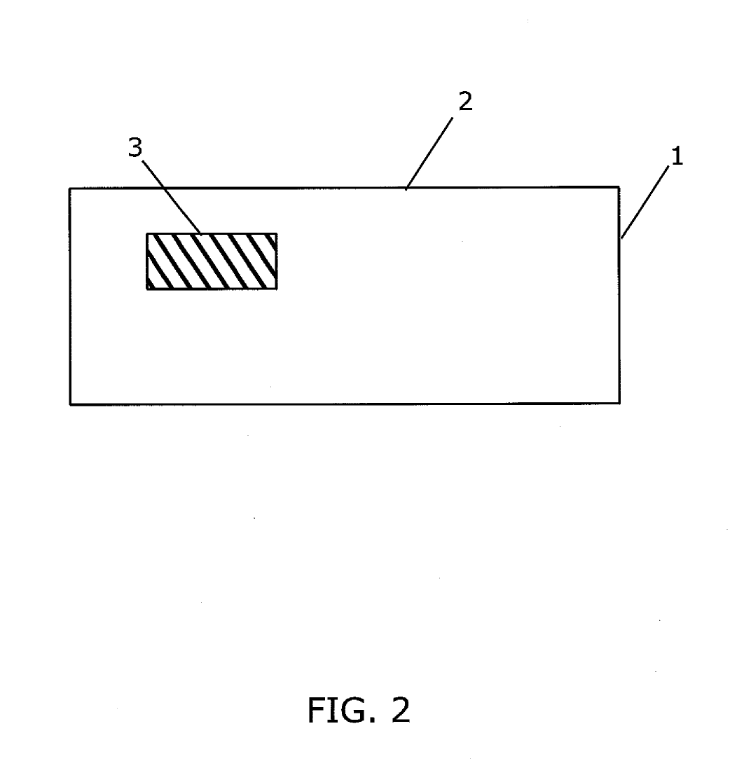

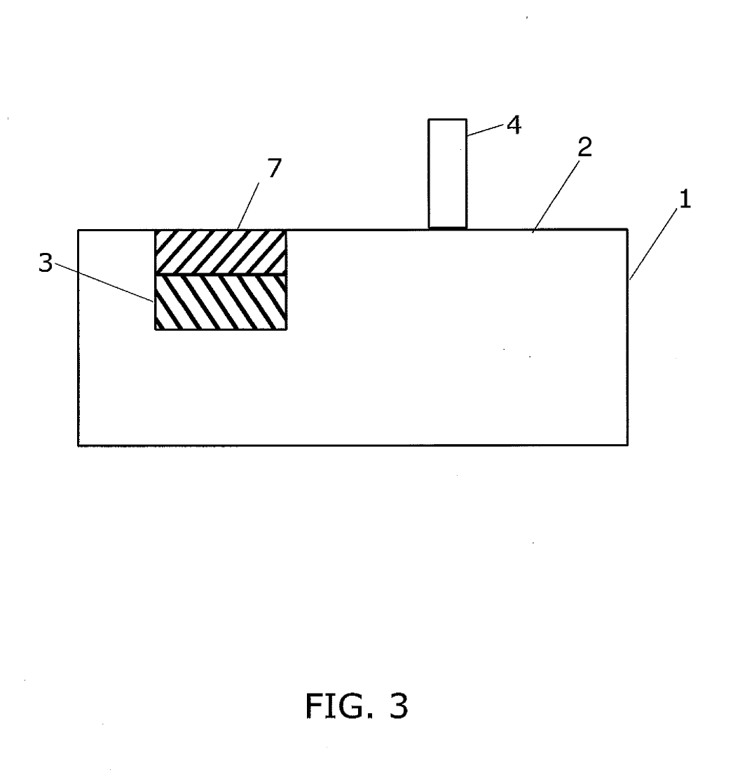

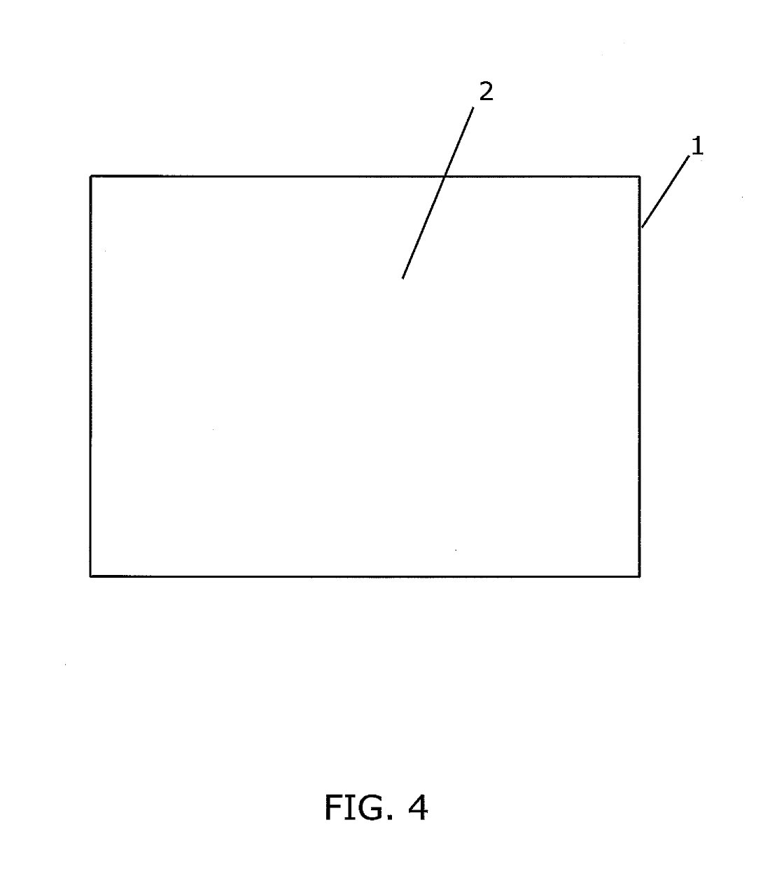

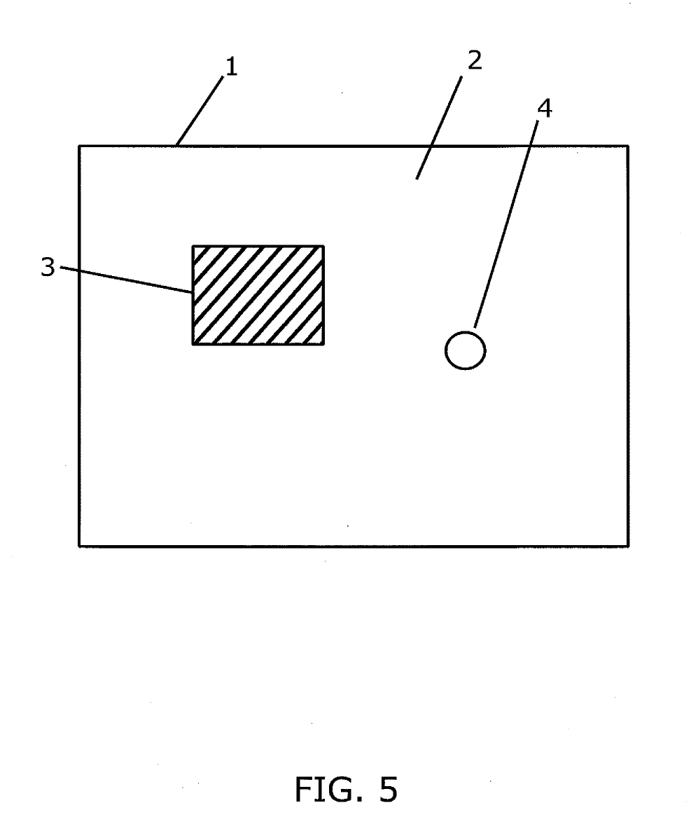

As shown in FIG. 2, a workpiece 1 includes a surface 2 and a subsurface defect 3. As is further shown in FIGS. 2 and 4, subsurface defect 3 is not visible to the naked eye and creates no detectable surface irregularity. FIG. 3 shows the same workpiece 1 undergoing metal processing and on to which is directed focused heat energy 4 from an energy point source. As shown in FIG. 1, the area distal from the point of incidence of focused heat energy 4 include solid areas, hot zone 9 and remaining bulk 10, of workpiece 1. Area 7 is that region of the solid area that is above defect 3. FIG. 5 shows the location of area 7 and subsurface defect 3 from a top plan view. Defect 3 is shown in phantom in FIG. 5 as it is not visible on the surface of workpiece 1.

As shown in FIG. 1, when an energy point source (e.g., a laser) delivers focused emitted energy (e.g., a beam) 4 on to a workpiece, the laser energy directed at the substrate (input energy) is absorbed by the substrate and causes local heat. Upon beam 4 impacting the workpiece a melt pool 8 is formed in the workpiece. Solid portions, hot zone 9 and bulk portion 10, constitute the solid portion 6 of workpiece 1 and contain heat input into the system by the energy point source.

By virtue of the heat energy input into the system and the conductivity of workpiece 1, solid portion 6 will emit incandescent radiation. Experience has shown that in the case of a substrate receiving energy from a point source and having a subsurface defect, the material above the defect will have a higher temperature than the material without a defect underneath. This temperature difference results in a thermal conductivity difference between the solid material and the inhomogeneity (defect) caused by the defect. The area with the defect will yield a higher incandescence (radiation within the visible light spectrum). In turn, the incandescence can be characterized by color or intensity gradient instead of the temperature itself. Hence, in order to detect the subsurface defect, one need only look for differences in the color or intensity of radiation coming from the solid portions of the work piece that are due to the melt pool generating heat energy. No adjunct radiation or illumination is necessary

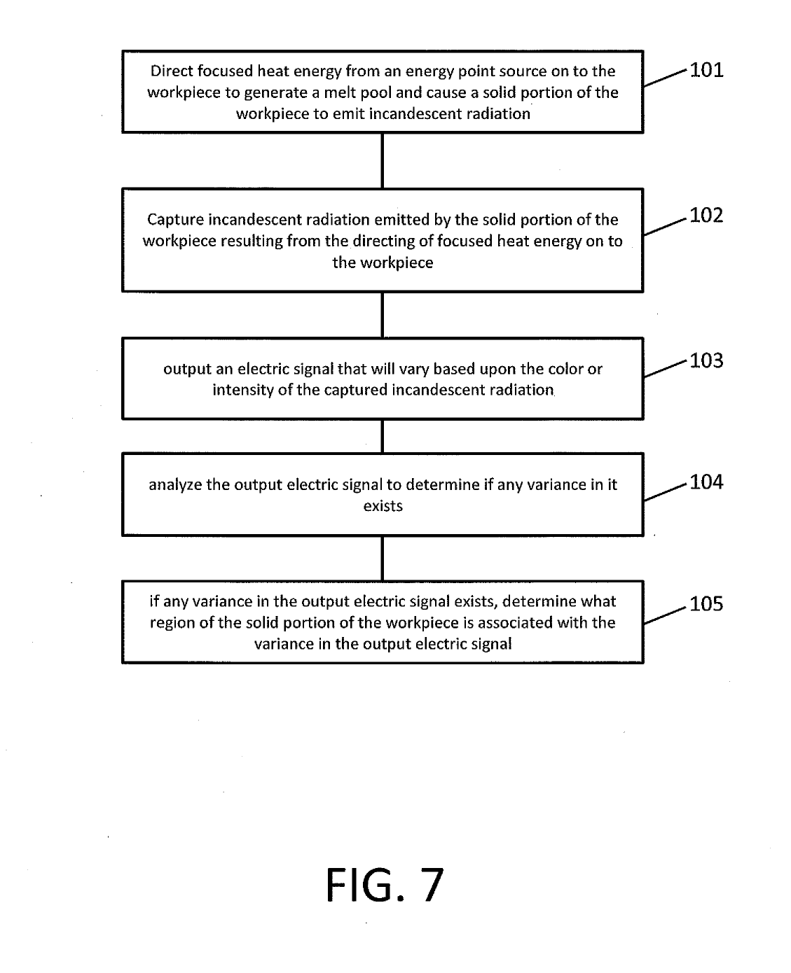

Thus, in one embodiment the invention is directed to a method for detecting a subsurface defect in a homogenous (typically, but not necessarily metal) workpiece undergoing processing. This embodiment method is shown in flowsheet depiction in FIG. 7. The method comprises a step 101 of directing focused heat energy from an energy point source on to the workpiece to generate a melt pool and cause a solid portion of the workpiece to emit incandescent radiation. In step 102 the incandescent radiation emitted by the solid portion of the workpiece resulting only from the directing of focused heat energy on to the workpiece is captured. The incandescent radiation is captured by a photon measurement device such as a CCD sensor or CMOS sensor. In step 103 the photon measurement device outputs an electric signal that will vary based upon the color or intensity of the captured incandescent radiation. In step 104 the output electric signal is analyzed to determine if any variance in it exists. In step 105 if any variance in the output electrical signal is detected, then the region of the workpiece associated with the variance in the output electrical signal is determined.

As noted, the photon measurement device that captures the incandescent radiation and outputs an electric signal that varies in accordance with the color or intensity of that radiation could be a CCD or CMOS sensor. More preferably, the photon measurement device will also map the spatial distribution of the color or intensity of the captured incandescent radiation akin to a CCD or CMOS camera, though it is not necessary that a human viewable display be generated by the map. The map could be generated in the form of an electronic file or signal readable by a processor such that the processor could determine the location of the variance-causing defect on the workpiece. The processor could then instruct the system to re-process the area to eliminate the defect.

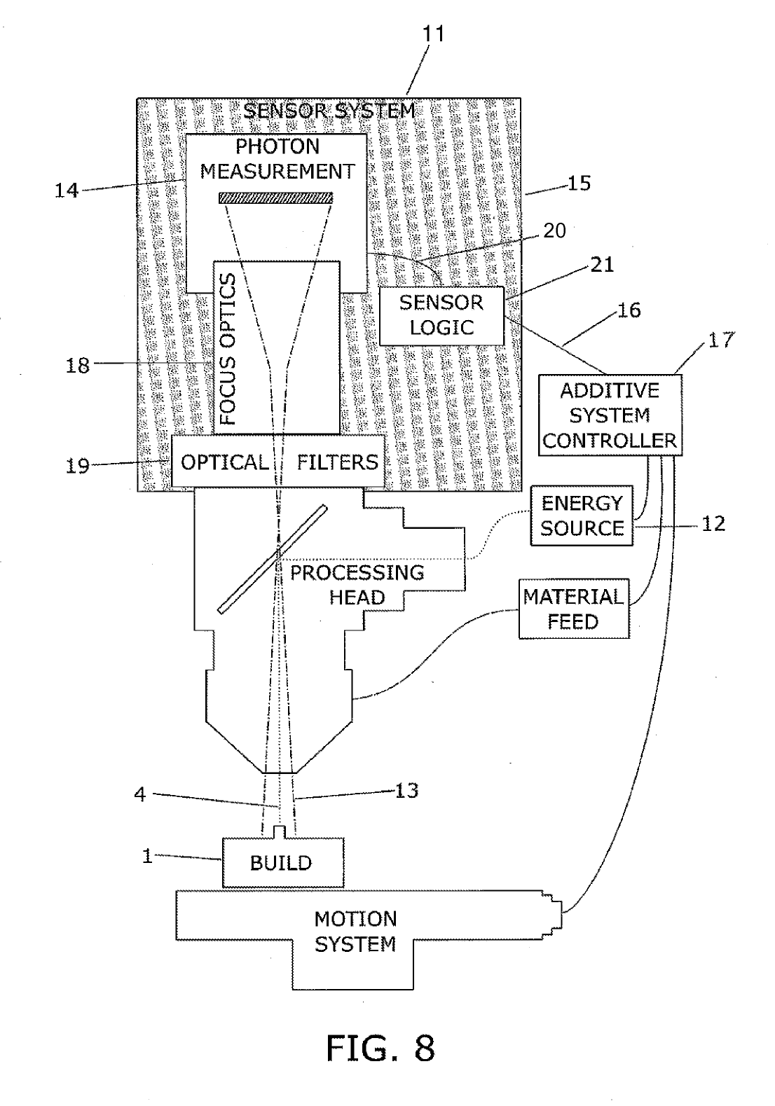

In another embodiment the invention is directed to a system 11 for detecting a subsurface defect in a homogeneous workpiece undergoing processing. This system is depicted in FIG. 8. System 11 comprises an energy point source 12 configured to deliver focused heat energy 4 to the workpiece 1 to generate a melt pool and cause a solid portion of the workpiece to emit incandescent radiation 13. System 11 includes a photon measurement device (e.g., a CCD or CMOS sensor) 14 adapted to capture the incandescent radiation emitted by the solid portion of the workpiece due to the delivered focused heat energy. Photon measurement device 14 can be part of a sensor system 15 that includes focusing optics 18, filtering optics 19 and processor 21. Photon measurement device 14 outputs a signal 20 based upon the captured incandescent radiation 13, which signal 20 will vary based upon the color or intensity of the captured radiation. System 11 also has a processor 21 configured to a) process the signal output by the photon measurement device and determine if any variance in the output electric signal exists; and b) if any such variance exists, determine (based upon inputs such as tool path and additive path data) what region of the of the solid portion of the workpiece is associated with the variance of the output electric signal. The variance of the electric signal coincides with any gradient in the color or intensity distribution of the captured incandescence. In a preferred embodiment system, processor 21 maps the spatial distribution of the color or intensity of the captured incandescent radiation which allows for a spatial representation of any subsurface defect in the workpiece. Based upon the analysis of signal 20 from photon measurement device 14, processor 21 can communicate a command signal 16 to system controller 17.

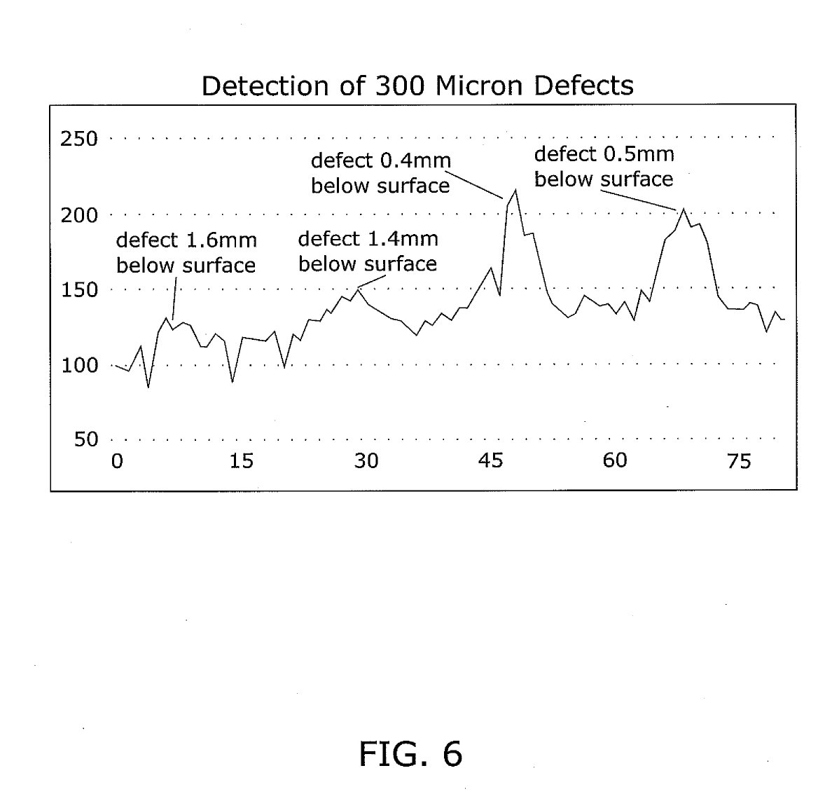

Although the invention is described mostly in the context of direct metal deposition, it can be used directly or indirectly for other manufacturing processes involving a high energy source, such as welding, cladding, plasma, thermal spray or electron beam techniques. The reliability of the invention has been tested. In this respect, a CMOS camera was used to demonstrate the invention. A CMOS camera was used to image the laser travel across a stainless steel substrate. 300 micron sub-surface defects were slotted into the substrate at depths of 1.6 mm, 1.5 mm, 0.4 mm and 0.5 mm. Owing to the presence of the 300 micron defects the heat dissipation in the workpiece was disrupted which manifested as a change in surface intensity when the laser beam travels across the defects and is captured in the images taken using the off-axis CMOS camera. This effect can be better seen in FIG. 6. As shown in FIG. 6 the defects located below 0.5 mm below the surface can be easily detected using the invention. The defect above 1.4 mm could be detected with some adjustments. Because most of the layer thickness of metal additive manufacturing processes is below 0.2 mm (200 microns), the inventive system and method work reliably well.

The process described herein can also be used in connection with other traditional welding techniques, such as tungsten inert gas (“TIG”) welding, gas metal arc welding (“GMAW”), plasma transferred arc (“PTA”) welding and electron beam (“EB”) welding. While the embodiments of the method and system of the present invention have been described herein, numerous modifications, alterations and changes to the described embodiments are possible without departing from the scope of the invention. The embodiments described herein are not intended to be limiting.

What is claimed is:

1. A method for detecting a subsurface defect in a workpiece undergoing processing, the method comprising:
a) directing focused heat energy from an energy point source on to the workpiece to generate a melt pool and cause a solid portion of the workpiece to emit incandescent radiation;
b) capturing the incandescent radiation emitted by the solid portion of the workpiece;
c) outputting an electric signal that will vary based upon the color or intensity of the captured incandescent radiation;
d) analyzing the output electric signal to determine if any variances in it exists; and
e) if any variance in the output electric signal exists, determining what region of the solid portion of the workpiece is associated with the variance of the output electric signal.

2. The method of claim 1 wherein steps b and c are performed by a charge coupled device.

3. The method of claim 1 wherein steps b and c are performed by a photon measurement device that maps the spatial distribution of the color or intensity of the captured incandescent radiation.

4. A system for detecting a subsurface defect in a workpiece, the system comprising:
a) an energy point source configured to deliver focused heat energy to the workpiece to generate a melt pool and cause a solid portion of the workpiece to emit incandescent radiation;
b) a sensor adapted to capture the incandescent radiation emitted by the solid portion of the workpiece that is due only from the focused heat energy that generates the melt pool and output a signal that will vary based upon the color or intensity of the captured incandescent radiation; and
c) a processor configured to a) process the signal output by the sensor and determine if any variance in the output electric signal exists; and b) if any such variance exists, determine what region of the of the solid portion of the workpiece is associated with the variance of the output electric signal.

5. The system of claim 4 wherein the processor is further configured to map the spatial distribution of the color or intensity of the captured incandescent radiation.
